(19) United States
(12) Patent Application Publication
(10) Pub. No.: US 2008/0013486 A1
(43) Pub. Date: Jan. 17, 2008

(54) WIRELESS COMMUNICATION METHOD AND APPARATUS FOR USING FRACTIONAL CHANNELS TO SUPPORT COMMUNICATION SERVICES THAT USE HIGHER ORDER MODULATION

(75) Inventors: Prabhakar R. Chitrapu, Blue Bell, PA (US); Paul L. Russell JR., Pennington, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/773,595

(22) Filed: Jul. 5, 2007

Related U.S. Application Data
(60) Provisional application No. 60/830,085, filed on Jul. 11, 2006.

(51) Int. Cl. H04Q 7/00; H04J 9/00; H04Q 7/20

(52) U.S. Cl. 370/329; 370/336; 370/345; 455/450; 455/68

(57) ABSTRACT

A method and apparatus for enhancing communication services in an evolved global system for mobile communications (GSM)/enhanced data rates for GSM evolution (EDGE) radio access network (GERAN) are disclosed. At least one full rate physical channel and/or half rate physical channel are provided to support communication services that do not require higher order modulation (HOM), and at least one fractional rate physical channel is provided to support the communication services that require HOM. The fractional rate channel occupies N timeslots for every M frames of a channel, whereby N/M is less than one half. The fractional rate channel may be used when communication services are provided on a channel that uses either 16 or 32 quadrature amplitude modulation (QAM) in a dual transfer mode (DTM) session. The communications services include at least one of voice communication services, circuit switched (CS) services and supplementary services.

### CROSS REFERENCE TO RELATED APPLICATION

This application claims the benefit of U.S. Provisional Application No. 60/830,085 filed Jul. 11, 2006, which is incorporated by reference as if fully set forth.

### FIELD OF INVENTION

The present invention is directed to wireless communications. More particularly, the present invention is related to enhanced circuit switched (CS) messaging and supplementary services using higher order modulation (HOM) in an evolved global system for mobile communications (GSM)/enhanced data rates for GSM evolution (EDGE) radio access network (GERAN).

### BACKGROUND

GERAN refers to the globally dominant second generation (2G) digital cellular radio interface, which includes GSM, general packet radio service (GPRS) and EDGE. Since the year 2000, there have been several Releases 4-6 of the GERAN standard. Presently, technical work is going on towards the standardization of Release 7, of which GERAN evolution is a part.

There are several motivations for using GERAN evolution. For example, vendors of 2G and third generation (3G) dual mode wireless transmit/receive units (WTRUs) may want to exploit the hardware available for 3G functions for enhanced GERAN functions. Furthermore, operators would like to provide service continuity between 2G and 3G networks, (e.g., downloads of video clips of sporting events).

HOM schemes are currently being investigated to increase the number of bits per symbol. This intrinsic capability can be utilized to increase the “user data rates” and/or lower the “coding rates”. This, in turn, results in a number of new modulation and coding schemes (MCSs).

In particular, the 16 quadrature amplitude modulation (QAM) and 32 QAM schemes are receiving considerable attention in the GERAN evolution studies. Possible signal constellations are shown in FIG. 1. The bits can be mapped to the symbols using Gray mapping. Groups of 4 or 5 bits are mapped onto a constellation point (symbol) for the 16 and 32 QAM schemes, respectively.

Voice communication services in GERAN are typically implemented via traditional CS techniques, (although voice over Internet protocol (IP) (VoIP) service is theoretically possible via packet switched (PS) techniques). In the CS approach, GERAN uses one of the various speech vocoders (full rate vocoder, enhanced full rate vocoder, half rate vocoder, and the like), on either a full rate channel or a half rate channel.

FIG. 2 depicts a graphical representation of frames that use conventional full rate and half rate physical channels during specific timeslots, where “F” indicates a full rate channel and “H” indicates a half rate channel. The origin in FIG. 2 is at the top left corner (time=0). Time increases along the first column in the vertical downward direction and continues at the top of the second column and runs downward again. The first column represents a frame that is partitioned into 8 cells, each representing a timeslot. The full rate GERAN channel F consists of one timeslot (0.577 msec) every frame (4.616 msec), whereas a half rate channel H consists of one timeslot every other frame.

Each timeslot carries a radio burst, of which there are several types. Voice traffic is carried by a normal burst. The structure of the normal bursts for a Gaussian minimum shift keying (GMSK) and an 8 phase shift keying (8 PSK) modulation schemes are shown below in Tables 1A and 1B, respectively.

TABLE 1A
(Normal burst for GMSK)

| Bit Number (BN) | Length of field | Contents of field |
|---|---|---|
| 0-2 | 3 | tail bits |
| 3-60 | 58 | Coded data bits |
| 61-86 | 26 | training sequence bits |
| 87-144 | 58 | Coded data bits |
| 145-147 | 3 | tail bits |
| 148-156 | 8.25 | Guard period |

TABLE 1B
(Normal burst for 8 PSK)

| | Length of field | |
|---|---|---|
| Bit Number (BN) | (bits) | Contents of field |
| 0-8 | 9 | tail bits |
| 9-182 | 174 | Coded data bits |
| 183-260 | 78 | training sequence bits |
| 261-434 | 174 | Coded data bits |
| 435-443 | 9 | tail bits |
| 444-468 | 24.75 | guard period |

In addition to voice communications, there are several other CS services, such as fax services. Also, messaging services are CS services that include short message service (SMS) and multimedia message service (MMS). Supplementary services include call handling services, caller identification (ID), and the like.

The GERAN evolution takes into consideration WTRU receive diversity, dual-carrier and multi-carrier downlink (DL), dual-carrier and multi-carrier uplink (UL), new modulation schemes and turbo codes, dual symbol rate, new burst structures and new slot formats, adaptation between WTRU diversity and dual-carrier, power control in frequency hopping, latency enhancements, and enhancements to resource allocation.

HOM is primarily proposed in GERAN evolution to improve packet data services. However, conventional full rate and half rate CS channels are inefficient to carry voice communications when HOM, such as 16 QAM, 32 QAM and the like is used. This is due to the capacity of the full rate and half rate channels being increased with the usage of HOM, whereas the data rates required for voice communication are not increased. For example, using 32 QAM increases the channel capacity by a factor of 5, as compared to GMSK modulation, and by a factor of 5/3 as compared to 8 PSK.

### SUMMARY

The present invention provides a method and apparatus for enhancing communication services in GERAN are disclosed. At least one full rate physical channel and/or half rate physical channel are provided to support communication services that do not require higher order modulation (HOM), and at least one fractional rate physical channel is provided to support the communication services that require HOM. The fractional rate channel occupies N timeslots for every M frames of a channel, whereby N/M is less than one half. The fractional rate channel may be used when communication services are provided on a channel that uses either 16 or 32 QAM in a dual transfer mode (DTM) session. The communications services include at least one of voice communication services, CS services and supplementary services.

### BRIEF DESCRIPTION OF THE DRAWINGS

The foregoing summary, as well as the following detailed description of the preferred embodiments of the present invention will be better understood when read with reference to the appended drawings, wherein:

FIG. 1 shows conventional signal constellations for 16 QAM and 32 QAM schemes;

FIG. 2 shows a graphical representation of conventional frames that use full rate and half rate physical channels during specific timeslots;

FIG. 3 shows a graphical representation of frames that use full rate, half rate and a fractional, (e.g., quarter), rate channel during specific timeslots in accordance with the present invention; and

FIG. 4 is a block diagram of an apparatus configured in accordance with the present invention.

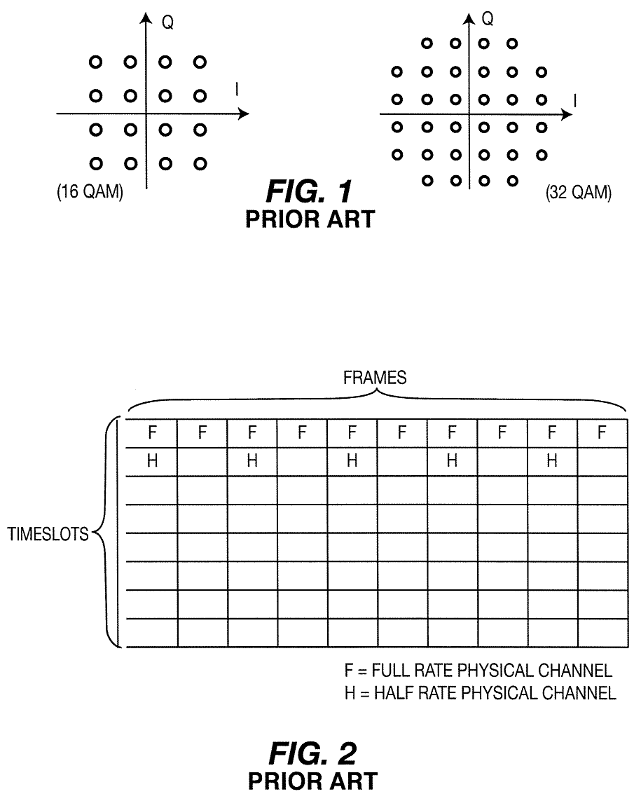

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment. The present invention is relevant to both WTRUs and base stations.

The present invention is related to the use of HOM, (e.g., 16 QAM, 32 QAM and 64 QAM), which is used to increase the peak and average data rates when channel conditions are satisfactory, and enhance the reliability of data transmission by reducing the bit error rate (BER) of received data while keeping the data rate unchanged.

The present invention describes the use of fractional physical channels, with reduced capacity. Specifically, the fractional physical channels are characterized by a rate N/M, where N and M are integers and N/M is less than one half. The fractional rate channel occupies N timeslots for every M frames of a channel. Examples include 1/4, 1/8, 2/5, and the like.

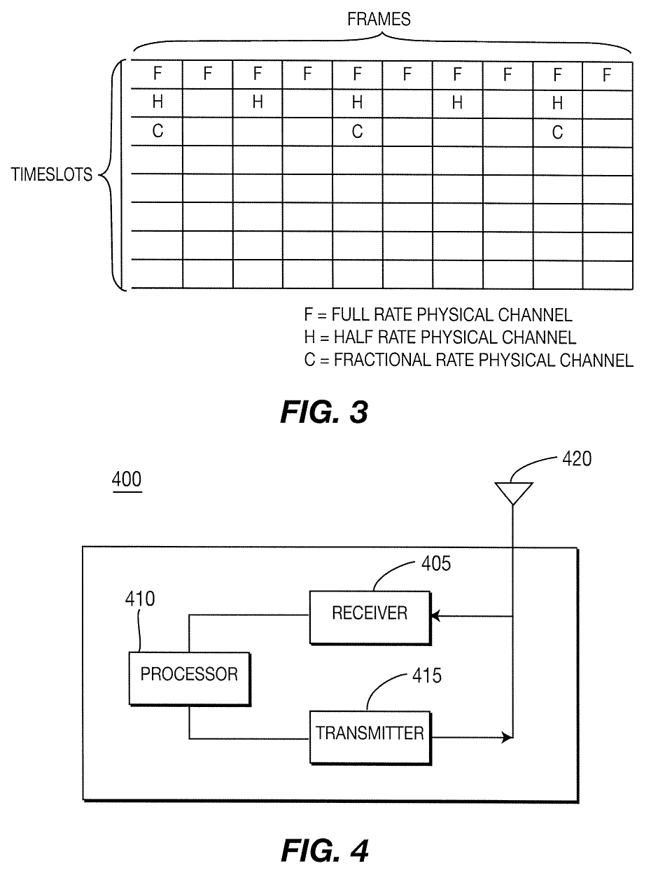

FIG. 3 shows a graphical representation of frames that use full rate channels F, half rate channels H and quarter rate channels C during specific timeslots in accordance with the present invention. The lower capacity of the fractional physical channels is adequate for voice communications, so that the remaining capacity of the available radio spectrum is made available by additional packet and/or PS services. A modified burst to be used with HOM is provided in accordance with the present invention, as shown in Table 2.

In accordance with a first embodiment of the present invention, a generalized fractional rate N/M physical channel wherein the fractional rate channel occupies N timeslots for every M frames of a channel, such that the channel only occupies only one timeslot in any one frame, and the index of the assigned timeslots of each frame that the channel occupies (e.g., 1 through 8) is the same in all assigned frames. As shown in FIG. 3, the fraction rate physical channel “C” has 1 timeslot every four (4) frames. Thus, N=1 and M=4, and N/M=1/4, (i.e., a quarter rate physical channel). The number of assigned timeslots per frame may be arbitrary, (e.g., ≦8).

Voice communication is typically carried using a full rate physical channel or a half rate physical channel. In other words, the average bit rate required to support voice communication using one of the several vocoders in GERAN, (such as full rate vocoder, enhanced full rate vocoder, half rate vocoder or adaptive multirate vocoder), is adequately supported by a full rate or half rate physical channels.

When HOM is introduced in GERAN, the number of bits carried per timeslot is increased compared to the legacy modulation schemes. For example, 32 QAM allows 5 times as many bits to be sent as GMSK. However, in general, communication using 32 QAM may require better channel conditions than GMSK. Accordingly, in cases where the channel conditions are sufficient to support 32 QAM communications, assigning a full rate physical channel would be wasteful to carry on a voice communication. Accordingly, it is proposed in this invention that a suitable fractional rate channel is used in such cases. For example, a quarter rate channel may be adequate. Clearly, other adaptive applications of fractional channels are also taught by the present invention.

In accordance with the present invention, lower rate physical channels, such as a quarter rate physical channel or the like, are defined. The present invention provides fractional channels, (e.g., 1/N or N/M rate channels), for voice and similar CS, which are presently forced to use either a full rate or a half rate channel. When used with HOM bursts, these channels use up more bandwidth than is needed for such services and, in the prior art, there is no way to allocate smaller amounts of radio resources. In accordance with the present invention, the fractional channels achieve this and consequently allow a larger portion of the radio carriers to be used for PS services.

In another embodiment, there is a dual transfer mode (DTM) in GERAN that refers to an operation mode for the WTRU and the base station, where both CS and PS channels are allocated at the same time. The CS resources, (i.e., channels), are used for real time applications such as voice communication. The PS resources are typically used for data applications. When a WTRU is communicating in DTM, high data rates are typically required to support the data oriented PS applications. Accordingly, depending upon the channel conditions and other system related parameters, HOM may be invoked.

For example, consider that 32 QAM is being used in a DTM session. It is advantageous that the HOM used is the same for the CS channel as well as PS channel. Since the PS channel is advantageously using 32 QAM, it follows that it is advantageous for the CS channel also to use 32 QAM. Another reason for such a preference is that the WTRU does not have to switch between different modulation schemes, which could be complex from an implementation point of view. Since CS services often do not require higher data rates made possible by the 32 QAM, it is advantageous for the CS services to be provided by fractional channels, thereby optimizing the use of precious radio resources.

In another embodiment, voice communication occurs via a logical channel (TCH) as well as a logical slow associated control channel (SACCH). Use of fractional channels is justified as explained above, when HOM is used. However, it may be that the use of fractional channels may cause increased latencies, which may be especially undesirable for the control channels. In accordance with the present invention, a hybrid scheme is used in which traffic communications are conducted on at least one fractional channel, whereas control communications are conducted on a regular full rate or half rate channel. In other words, a multiplexing of fractional and regular physical channels is provided. For example, the control channel is constructed as a regular physical channel consisting of a regular sequence of timeslots, occurring every 26 frames, which constitutes a multiframe in GERAN. The traffic channel may be a quarter rate channel as described above.

As the TCHs are now being defined as fractional rate channels in the present invention, the average bit rate of the SACCHs is also reduced, which may or may not be adequate for a chosen application. If it is not adequate, new hybrid channel combinations can be proposed, whereby a fractional rate TCH is associated with a full rate or half rate SACCH. It is to be noted that the capacity of SACCHs is inherently quite small compared to that of TCHs, (as it is only used for signaling), and therefore the penalty of using full rate and/or half rate physical channels for such signaling purposes is not inefficient. Such channels may be termed as 1/N rate fractional channels, with N=2, 3, 4, etc.

There are several ways in which the higher bit carrying capacity of an HOM-based burst can be used to improve CS services, such as voice and fax. For example, consider CS voice communications using a full rate vocoder on a full rate physical channel, using GMSK-based normal bursts. Since each 16 QAM based burst carries 4 times the number of data bits, the voice communication data bits can be transported on a quarter rate physical channel. This, in turn, increases the number of users that can be supported per GERAN carrier and hence the network capacity, in terms of number of users supported per cell.

Alternately, the larger number of coded data bits per burst can be used to decrease the code rate, thereby improving the ability to correct for channel errors while occupying the same full rate physical channel.

Additionally, the above scheme can be applied to CS fax services, as well as any other CS schemes, such as video streaming calls and the like.

The above ideas of using the larger number of coded bits can further be applied to messaging services, such as short message service (SMS), multimedia messaging service (MMS) and the like. Since these services tend to be bursty in nature, using HOM based bursts will dramatically improve the capacity in terms of number of users served or messages delivered, decrease the latency or otherwise improve performance over error-prone channels by reducing the number of lost or erroneous packets and consequent retransmission of messages.

The present invention provides a new normal burst structure for 16-QAM, as shown below in Table 2. Note that the total number of bits is now 937.5, which is 4 times the number of bits with GMSK modulation, (whose constellation size is 2 instead of 16).

TABLE 2
(Normal burst for 16 QAM)

| | Length of field | |
|---|---|---|
| Bit Number (BN) | (bits) | Contents of field |
| 0-11 | 12 | tail bits |
| 12-243 | 232 | Coded data bits |
| 244-347 | 104 | training sequence bits |
| 348-579 | 232 | Coded data bits |
| 580-591 | 12 | tail bits |
| 592-624 | 33 | guard period |

Normal bursts can similarly be defined for 32 QAM and 64 QAM. Various schemes to improve CS voice communications over physical channels carrying HOM scheme based bursts may be employed.

Finally, GERAN defines a number of supplementary services, such as call waiting, caller ID and the like, which requires the transmission of short bursts. These tend to interrupt normal flow of data transmission. In such cases, it is especially useful to employ HOM based bursts, as they will reduce the interruption times.

FIG. 4 is a block diagram of apparatus 400 configured in accordance with the present invention. The apparatus 400 may be a WTRU, a Node-B or any other type of transceiver. The apparatus 400 includes a receiver 405, a processor 410, a transmitter 415 and an antenna 420.

The apparatus 400 is used in a wireless communication system that supports the use of HOM. The transmitter 415 is configured to transmit a signal over at least one full rate and/or half rate physical channel that does not require HOM, and transmit a signal over at least one fractional rate physical channel that requires HOM.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communication system that provides communication services, a method of enhancing the capacity of the system to support the use of higher order modulation (HOM), the method comprising:
using at least one full rate physical channel for supporting the communication services that do not require HOM; and
using at least one fractional rate physical channel for supporting the communication services that require HOM, wherein the fractional rate physical channel occupies N timeslots for every M frames of a channel, where N and M are integers and N/M is less than one half.

2. The method of claim 1 wherein the fractional rate channel occupies one timeslot for every four frames of a channel.

3. The method of claim 1 wherein the wireless communication system is an evolved global system for mobile communications (GSM)/enhanced data rates for GSM evolution (EDGE) radio access network (GERAN).

4. The method of claim 3 wherein the at least one fractional rate channel is used when the communication services are provided on a channel that uses 16 quadrature amplitude modulation (QAM) in a dual transfer mode (DTM) session.

5. The method of claim 3 wherein the at least one fractional rate channel is used when the communication services are provided on a channel that uses 32 quadrature amplitude modulation (QAM) in a dual transfer mode (DTM) session.

6. The method of claim 1 wherein the communications services include at least one of voice communication services, circuit switched (CS) services and supplementary services.

7. The method of claim 1 wherein the fractional rate physical channel is a packet switched (PS) channel.

8. The method of claim 1 wherein the fractional rate physical channel is a circuit switched (CS) channel.

9. The method of claim 1 wherein the fractional rate physical channel is a logical traffic channel (TCH).

10. The method of claim 9 wherein the full rate physical channel carries control information and the fractional rate control channel carries traffic.

11. The method of claim 10 wherein the full rate physical channel is a logical slow associated control channel (SACCH).

12. The method of claim 1 wherein the fractional rate physical channel transports HOM-based bursts.

13. In a wireless communication system that provides communication services, a method of enhancing the capacity of the system to support the use of higher order modulation (HOM), the method comprising:
using at least one half rate physical channel for supporting the communication services that do not require HOM; and
using at least one fractional rate physical channel for supporting the communication services that require HOM, wherein the fractional rate physical channel occupies N timeslots for every M frames of a channel, where N and M are integers and N/M is less than one half.

14. The method of claim 13 wherein the fractional rate channel occupies one timeslot for every four frames of a channel.

15. The method of claim 13 wherein the wireless communication system is an evolved global system for mobile communications (GSM)/enhanced data rates for GSM evolution (EDGE) radio access network (GERAN).

16. The method of claim 15 wherein the at least one fractional rate channel is used when the communication services are provided on a channel that uses 16 quadrature amplitude modulation (QAM) in a dual transfer mode (DTM) session.

17. The method of claim 15 wherein the at least one fractional rate channel is used when the communication services are provided on a channel that uses 32 quadrature amplitude modulation (QAM) in a dual transfer mode (DTM) session.

18. The method of claim 13 wherein the communications services include at least one of voice communication services, circuit switched (CS) services and supplementary services.

19. The method of claim 13 wherein the fractional rate physical channel is a packet switched (PS) channel.

20. The method of claim 13 wherein the fractional rate physical channel is a circuit switched (CS) channel.

21. The method of claim 13 wherein the fractional rate physical channel is a logical traffic channel (TCH).

22. The method of claim 21 wherein the half rate physical channel carries control information and the fractional rate control channel carries traffic.

23. The method of claim 22 wherein the half rate physical channel is a logical slow associated control channel (SACCH).

24. The method of claim 13 wherein the fractional rate physical channel transports HOM-based bursts.

25. Apparatus used in a wireless communication system that supports the use of higher order modulation (HOM), the apparatus comprising:
an antenna; and
a transmitter configured to transmit a signal over at least one full rate physical that does not require HOM, and transmit a signal over at least one fractional rate physical channel that requires HOM, wherein the fractional rate physical channel occupies N timeslots for every M frames of a channel, where N and M are integers and N/M is less than one half.

26. The apparatus of claim 25 wherein the fractional rate channel occupies one timeslot for every four frames of a channel.

27. The apparatus of claim 25 wherein the wireless communication system is an evolved global system for mobile communications (GSM)/enhanced data rates for GSM evolution (EDGE) radio access network (GERAN).

28. The apparatus of claim 27 wherein the at least one fractional rate channel is used to support communication services that are provided on a channel that uses 16 quadrature amplitude modulation (QAM) in a dual transfer mode (DTM) session.

29. The apparatus of claim 27 wherein the at least one fractional rate channel is used to support communication services that are provided on a channel that uses 32 quadrature amplitude modulation (QAM) in a dual transfer mode (DTM) session.

30. The apparatus of claim 28 wherein the communications services include at least one of voice communication services, circuit switched (CS) services and supplementary services.

31. The apparatus of claim 25 wherein the fractional rate physical channel is a packet switched (PS) channel.

32. The apparatus of claim 25 wherein the fractional rate physical channel is a circuit switched (CS) channel.

33. The apparatus of claim 25 wherein the fractional rate physical channel is a logical traffic channel (TCH).

34. The apparatus of claim 33 wherein the full rate physical channel carries control information and the fractional rate control channel carries traffic.

35. The apparatus of claim 34 wherein the full rate physical channel is a logical slow associated control channel (SACCH).

36. The apparatus of claim 25 wherein the signal transmitted over the at least one fractional rate physical channel includes HOM-based bursts.

37. The apparatus of claim 25 wherein the apparatus is a wireless transmit/receive unit (WTRU).

38. The apparatus of claim 25 wherein the apparatus is a Node-B.

39. Apparatus used in a wireless communication system that supports the use of higher order modulation (HOM), the apparatus comprising:
an antenna; and
a transmitter configured to transmit a signal over at least one half rate physical channel that does not require HOM, and transmit a signal over at least one fractional rate physical channel that requires HOM, wherein the fractional rate physical channel occupies N timeslots for every M frames of a channel, where N and M are integers and N/M is less than one half.

40. The apparatus of claim 39 wherein the fractional rate channel occupies one timeslot for every four frames of a channel.

41. The apparatus of claim 39 wherein the wireless communication system is an evolved global system for mobile communications (GSM)/enhanced data rates for GSM evolution (EDGE) radio access network (GERAN).

42. The apparatus of claim 41 wherein the at least one fractional rate channel is used to support communication services that are provided on a channel that uses 16 quadrature amplitude modulation (QAM) in a dual transfer mode (DTM) session.

43. The apparatus of claim 41 wherein the at least one fractional rate channel is used to support communication services that are provided on a channel that uses 32 quadrature amplitude modulation (QAM) in a dual transfer mode (DTM) session.

44. The apparatus of claim 42 wherein the communications services include at least one of voice communication services, circuit switched (CS) services and supplementary services.

45. The apparatus of claim 39 wherein the fractional rate physical channel is a packet switched (PS) channel.

46. The apparatus of claim 39 wherein the fractional rate physical channel is a circuit switched (CS) channel.

47. The apparatus of claim 39 wherein the fractional rate physical channel is a logical traffic channel (TCH).

48. The apparatus of claim 47 wherein the half rate physical channel carries control information and the fractional rate control channel carries traffic.

49. The apparatus of claim 48 wherein the half rate physical channel is a logical slow associated control channel (SACCH).

50. The apparatus of claim 39 wherein the signal transmitted over the at least one fractional rate physical channel includes HOM-based bursts.

51. The apparatus of claim 39 wherein the apparatus is a wireless transmit/receive unit (WTRU).

52. The apparatus of claim 39 wherein the apparatus is a Node-B.
